(19) United States
(12) Patent Application Publication
(10) Pub. No.: US 2021/0254249 A1
(43) Pub. Date: Aug. 19, 2021

(54) METHOD FOR TREATING A TEXTILE MATERIAL WEB AND APPARATUS FOR TREATING A TEXTILE MATERIAL WEB

(71) Applicant: ANDRITZ KUESTERS GMBH, KREFELD (DE)

(72) Inventors: CHRISTIAN JUNG, TOENISVORST (DE); PASCAL LOEST, MOERS (DE)

(73) Assignee: ANDRITZ KUESTERS GMBH, KREFELD (DE)

(21) Appl. No.: 17/261,033

(22) PCT Filed: Jun. 25, 2019
(86) PCT No.: PCT/EP2019/066826

§ 371 Date: Jan. 18, 2021

(30) Foreign Application Priority Data
Jul. 26, 2018 (DE) 10 2018 118 096.9

(51) Int. Cl. D06C 15/02; G01N 15/08; D06C 7/00; B60R 21/235

(52) U.S. Cl. CPC D06C 15/02; G01N 15/08; D06C 7/00; B60R 21/36; B60R 2021/23533; B60R 2021/23509; B60R 21/235

(57) ABSTRACT

A method for treating a textile material web for reducing a gas-permeability of the textile material web. The method includes providing the textile material web with a first side having a planar configuration and a second side having a planar configuration, the first side being opposite to the second side, transporting the textile material web in an advancing direction, and reducing the gas permeability of the textile material web. The gas permeability of the textile material web is reduced by applying water to the first side and/or the second side of the textile material web, guiding the textile web material through a first treatment gap which is formed by a first treatment roller and a first counter tool, and in the first treatment gap, pressure treating the textile material web and thermally treating the first side and/or the second side of the textile material web.

### CROSS REFERENCE TO PRIOR APPLICATIONS

This application is a U.S. National Phase application under 35 U.S.C. § 371 of International Application No. PCT/EP2019/066826, filed on Jun. 25, 2019 and which claims benefit to German Patent Application No. 10 2018 118 096.9, filed on Jul. 26, 2018. The International Application was published in German on Jan. 30, 2020 as WO 2020/020557 A1 under PCT Article 21(2).

### FIELD

The present invention relates to a method for treating a textile material web, in particular a woven-fabric material web suitable for forming an airbag, to reduce the gas-permeability or air-permeability of the material web, in particular in the direction of the material thickness, in which method the material web comprising a first side of planar configuration and an opposite second side of planar configuration is transported in an advancing direction and guided through at least one treatment gap formed by a treatment roller and a counter tool. The present invention furthermore relates to an apparatus for treating a textile material web in an advancing direction for reducing the gas-permeability of the material web, in particular in the direction of the material thickness.

### BACKGROUND

Various such methods for usually continuously treating a material web are known, in particular also such methods for producing a woven fabric suitable for the application as or on an airbag. Such an application is in particular to be understood to be the use of the woven fabric for or as an impact cushion or a gas bag of an airbag unit and/or of an airbag safety system. The material web herein can comprise the woven-fabric material for a multiplicity of such impact cushions, wherein the woven fabric and/or the material web is typically composed of interconnected synthetic fibers.

A linear force is preferably substantially exerted on the woven fabric that is guided through the gap in the treatment gap. The counter tool is preferably configured as a counter roller therefor. The counter roller, conjointly with the treatment roller, can consequently form the treatment gap, also referred to as the nip. It is to be highlighted that the side of planar configuration is presently to be understood to be a flat side of the material web, in particular a surface of that side. The side of planar configuration can in particular form an upper side or a lower side of the material web. The direction of the material thickness is furthermore to be understood to be a thickness direction of the material web, i.e., the direction which is substantially perpendicular to at least one plane defined by the two sides of planar configuration of the material web, in particular substantially perpendicular to an upper side and a lower side of the material web.

Apart from a relatively high tearing strength, a decisive criterion of the woven fabric for an application as an airbag is the air-permeability and/or gas-permeability of the woven fabric. The gas-permeability of the woven airbag fabric plays a substantial role in particular in the side airbags or the pedestrian airbags of a vehicle which are nowadays increasingly installed and in which a gas bag with a relatively large area is inflated explosively in a very short time. There is in particular the requirement of suppressing the gas-permeability at high-pressure conditions to a greater extent than in known standard airbags. The gas bag, also in the case of airbags with such a large area, must thus be designed so as to be relatively gas-impermeable at least for the first moment after the airbag unit has been triggered and the gas bag is being filled, so as to be able to retain the gas at least until part of a body of a person sinks into the airbag.

In order for a woven fabric with a low gas-permeability to be produced, in particular for use as an airbag, a likewise per se known in particular tear-resistant woven fabric is typically coated across a full area with silicone via known methods, for example, via a usual coating plant. The woven fabric therefore usually has an area weight of 100 to 500 g/m², for example, of 150 to 250 g/m². The silicone closes the pores of the woven fabric and thereby causes a significant reduction in the gas-permeability to almost zero. Further optional treatment steps, such as drying the woven fabric in a drying plant, can subsequently take place.

A method for producing a silicone-coated woven fabric for airbags is described, for example, in EP 2 199 062 A1. The method provides that a silicone layer is first applied to one of the sides of planar configuration of the woven fabric, the woven fabric is then guided into a drying oven, and is pressure treated in the drying oven by two calender rollers.

The relatively high costs for the silicone raw material, the relatively high weight of the woven fabric created on account of the coating, as well as the relatively high dimensional stability caused by the coating and the resulting difficulty in terms of the capability of folding the woven fabric for packing and integrating in other components, such as a gas bag in a steering wheel or a body spar of a vehicle, are, however, disadvantageous. The operating costs of such an apparatus can also be relatively high due to the required complexity with regards to cleaning the treatment plant.

A production method for a woven airbag fabric in which a non-coated woven fabric is provided and calendered on both sides is described in DE 690 16 007 T2. The woven fabric produced by this production method is disadvantageous in that the woven fabric has room for improvement in terms of its gas-permeability.

### SUMMARY

An aspect of the present invention is to provide a method for treating a textile material web for an application as an airbag which improves upon at least one of the above-mentioned disadvantages and is in particular able to be implemented in a cost-effective manner and is improved in terms of the weight and the folding capability of the final product. An aspect of the present invention is also to provide an apparatus for carrying out the method.

In an embodiment, the present invention provides a method for treating a textile material web for reducing a gas-permeability of the textile material web. The method includes providing the textile material web comprising a first side having a planar configuration and a second side having a planar configuration, the first side being opposite to the second side, transporting the textile material web in an advancing direction, and reducing the gas permeability of the textile material web in a first step. The first step includes applying water to at least one of the first side and the second side of the textile material web, guiding the textile web material through a first treatment gap which is formed by a first treatment roller and a first counter tool, and in the first treatment gap, pressure treating the textile material web and thermally treating at least one of the first side and the second side of the textile material web.

### BRIEF DESCRIPTION OF THE DRAWINGS

The present invention is described in greater detail below on the basis of embodiments and of the drawings in which:

FIG. 1 shows a left image part of an overall lateral sectional view of an embodiment of the apparatus according to the present invention for treating a textile material web; and

FIG. 2 shows a right image part of an overall lateral sectional view of an embodiment of the apparatus according to the present invention for treating a textile material web.

### DETAILED DESCRIPTION

According to the present invention, the method for treating the textile material web provides that, before passing and/or running through a treatment gap for calendering, water is applied to at least one of the two sides of planar configuration of the material web, and the material web is subsequently pressure treated in the treatment gap, and is thermally treated on at least one of the two sides of planar configuration, for example, on the side to which water has been applied.

It has surprisingly been demonstrated that, on account of the application of water, the gas-permeability of the woven fabric after calendering is improved compared to the dry calendering of the woven fabric. It has furthermore been demonstrated that, on account of the application of water instead of silicone, the folding capability of a woven fabric produced by the method according to the present invention is significantly improved compared to a woven fabric with a silicone coating.

The application of water can in principle take place in any arbitrary manner. Examples include pouring, dipping, coating with a doctor knife, splashing or spraying water, for example, via a known spraying installation and/or a humidifying installation, in particular via one or a plurality of spray nozzles or fogging nozzles. The water can, for example, be sprayed onto the at least one side of the material web, for example, via one or a plurality of rotary humidifiers.

In an embodiment, water can, for example, be applied to exactly one of the two sides of planar configuration of the material web before passing and/or running through a treatment gap for calendering.

In an embodiment, water can, for example, be applied to both sides of planar configuration of the material web before passing and/or running through a treatment gap for calendering.

In an embodiment, the water can, for example, be applied so that the water penetrates from the application side through the woven fabric to the non-application side. The material web herein can, for example, be uniformly soaked.

In an embodiment, the water can, for example, be applied so that the water does not penetrate from the application side through the woven fabric to the non-application side.

The water can be applied once or also multiple times.

The multiple application in the embodiment in which the water is applied so that the water does not penetrate from the application side through the woven fabric to the non-application side can take place multiple times from one side.

The multiple application in the embodiment in which the water is applied so that the water uniformly soaks the material web can take place multiple times from any arbitrary side.

The multiple application may be necessary when insufficient water is able to be applied by way of a single application and/or when both sides of the material web are to be uniformly moistened in a targeted manner, for example, when the temperature also acts from both sides.

Common tap water, in particular potable water, or an aqueous solution, for example, mixed with suitable additives such as, for example, a wetting agent, can, for example, be used as water.

A particularly cost-effective and environmentally friendly treatment of the material web is moreover provided on account of the application of water as an application agent and/or a moistening agent. The complexity of cleaning the apparatus is also minimized. The final product produced by this method, i.e., a woven fabric which is suitable for the application as an airbag, can moreover be easily folded and, on account thereof, is able to be packed in an uncomplicated manner and with relatively little effort in terms of force. A production rate which is higher compared to that of the dry calendering process can also be achieved.

Before passing the treatment gap, water can, for example, be applied to only one of the two sides of planar configuration of the material web. It has been demonstrated that a reduction of the gas-permeability in the thickness direction of the woven fabric can already be achieved thereby. It is to be understood that, in the case of water being applied to one side and/or water being applied to one side of the material web, the water can, for example, be applied to the material web exclusively to this one side. In another embodiment, before passing the treatment gap, water can, for example, simultaneously, thus in mutually identical or mutually overlapping temporal periods, or successively, be applied to both sides of planar configuration of the material web.

The thermal treatment of the material web under pressure and at least on one side provided according to the present invention, in combination with the water application explained above, can provide a particularly significant reduction of the gas-permeability of the woven fabric, in particular in the thickness direction. The gas-permeability of the woven fabric after the calendering is in particular significantly improved in comparison to the dry calendering of the woven fabric on account of the prior application of water. On account of water being applied at least to one side and the water subsequently being evaporated, in particular in a “shock-like” manner, under pressure and temperature in the treatment gap, the woven fabric can be increasingly compacted and pores in the woven fabric closed, i.e., the gas-permeability of the woven fabric reduced.

It has in particular been surprisingly demonstrated that the water vapor which is spontaneously formed after an application of water in the treatment gap, in conjunction with the water film adhering to the fiber surface, causes the fibers to slide or be displaced in relation to one another, thus causing intermediate spaces between fibers to be at least temporarily closed so that a compaction process takes place in particular between the fibers. The water vapor formed can moreover transmit thermal energy of the heating roller right into the interior of the woven fabric and thus contribute toward the glass transition temperature of the synthetic fibers being briefly exceeded. During subsequent cooling, the fibers, which on account of the sliding fibers lie on top of one another at least in regions, i.e., are disposed so as to partially overlap in the thickness direction (and on account of the simultaneous pressure treatment are, for example, partially flattened), are set in the arrangement relative to one another which in particular closes the intermediate spaces between the fibers and/or set in the partially flattened shape of the fibers, so as to reduce the gas-permeability of the woven fabric.

After the application of water, the material web can, for example, be thermally treated only on one of the two sides of planar configuration, in particular on the side to which water has been applied, for example, during the pressure treatment of the material web. It has been demonstrated that a reduction of the gas-permeability in the thickness direction of the woven fabric can already be achieved on account of a thermal treatment and pressure treatment of this type.

For the thermal treatment, the material web can, for example, be formed from synthetic fibers or a mixture of synthetic fibers and natural fibers. It is to be understood that the thermal treatment presently is understood to be the input of heat. This can fundamentally take place on one or both sides of planar configuration of the material web, in particular via the treatment roller and/or the counter tool. In the case of a thermal treatment on one side and/or a thermal treatment on one side of the material web, the heat can, for example, be applied to the material web exclusively to this one side. The heat here can of course be transmitted from the thermally treated side through the woven fabric to the side without thermal treatment. In the case of a thermal treatment on both sides and/or a thermal treatment on both sides of the material web, the heat can, for example, be applied to the material web on both sides. A thermal treatment on both sides can, for example, take place in those cases in which the water, in the case of water being applied to one side, penetrates from the application side through the woven fabric to the non-application side, or in cases in which water is applied to both sides of planar configuration of the material web.

In the case of a thermal treatment on one side, the treatment roller or the counter tool can, for example, be heated; in the case of a thermal treatment on both sides, the treatment roller and the counter tool are heated.

The method, apart from the advantages mentioned further above such as a cost-effective implementation as well as the advantageous properties of the woven fabric, thus provides a particularly effective treatment for reducing the gas-permeability of the woven fabric so that comparatively high production rates are possible compared to dry calendering processes. Tests have demonstrated that a maximum production rate of 5 m/min in the case of dry calendering was able to be increased to at least 15 m/min by applying water according to the present invention. The production rate herein depends heavily on the precursor material and the air-permeability to be achieved. The method according to the present invention can, for example, permit the production rate to be increased by a factor of 1.5 to 4, for example, by a factor of 3, compared to dry calendering.

In an embodiment of the present invention, the material web can, for example, be treated on both sides of planar configuration, in particular water is applied to both sides of planar configuration, and the material web is subsequently pressure treated and thermally treated in a treatment gap.

In an embodiment, a single-stage process can, for example, be provided. A one-off pressure treatment and thermal treatment can, for example, take place in the single-stage process, for example, in exactly one treatment gap.

A dual-stage process has, however, proven to be particularly advantageous. A particularly high reduction of the gas-permeability of the woven fabric in the thickness direction can thereby be advantageously achieved. A pressure treatment and thermal treatment can, for example, take place twice in the dual-stage process, for example, in two treatment gaps which are disposed in succession. It is here a primary objective to allow the temperature to act on the material web from both sides. The side to which water is applied herein is relevant only if so little is applied that the material web is not uniformly soaked. In this case, the application can, for example, takes place on the side on which the thermal input also takes place, should the latter take place only from one side.

The dual-stage process particularly, for example, takes place so that in a first treatment gap the material web is thermally treated exclusively on a first side of planar configuration, and in a second treatment gap the material web is thermally treated exclusively on a second side of planar configuration. This takes place in both treatment gaps, for example, via a coated roller with a heated counter roller. Water can, for example, be applied in each case ahead of each treatment gap. Since the water is in each case applied, for example, so that the water uniformly soaks the material web, it is possible but not necessary for the application to take place in each case from that side from where heat is introduced in the subsequent treatment gap.

In particular in the embodiment in which the water is applied so that the water does not penetrate from the application side through the woven fabric to the non-application side, the dual-stage process can also take place so that, in a first step, the material web is moistened exclusively on a first side of planar configuration and/or water is applied thereto, and in a first treatment gap is subsequently pressure treated and the moistened first side is, for example, exclusively thermally treated, and in a downstream second step, water is applied exclusively to a second side planar configuration of the material web, for example, via a separately configured second spraying installation, and is subsequently pressure-treated in a separate second treatment gap, and the moistened second side is, for example, exclusively thermally treated. In order for the method to be carried out in a simplified manner, it can be provided that the material web, before the material web is provided with water, is received or unwound from a first supply installation such as a winding roller or a batch roll, in particular from a first batch roll truck. Standard batch roll trucks, also referred to as batch trucks, can advantageously be used for linking and/or receiving a material web emanating from upstream processes such as woven-fabric production, for example, to or on an apparatus for treating the material web. Such a treatment apparatus for carrying out the method can in particular be integrated in a relatively uncomplicated and cost-effective manner in an existing plant system such as a production line. In order for tension on the material web to be controlled, the storage roll can be driven or braked in a motorized manner.

It is also possible for the method according to the present invention to be integrated in the production process of the material web, i.e., for the method to be used inline. It can advantageously be provided herein that the material web is acquired from an upstream installation such as a production plant, for example, from an installation for washing the woven fabric.

A refinement of the present invention provides that, after the treatment in the treatment gap, the material web is dried in a drying step. The material web can be guided in or on at least one cylinder dryer therefor, for example, be largely wrapped around the cylinder dryer, and be dried via the cylinder dryer, for example, by wrapping the material web in an S-shaped manner around the cylinder dryer.

In a last step, the material web can, for example, be wound onto a second storage roll, in particular of a second batch truck. The material web can be thereby supplied in a particularly simple manner to a downstream treatment installation. The quantity and/or the length of the material web can also be advantageously controlled according to requirements. Standard batch trucks can again be used for linking to the apparatus so that a relatively uncomplicated and cost-effective operation of the apparatus is enabled therefor. The storage roll can, for example, be driven in order for tension on the material web to be controlled.

A gas-permeability value of the material web can, for example, be detected and/or measured in at least one testing step. A deviation of an actual value from a nominal value of the gas-permeability can in particular be detected, and be emitted in the form of a signal such as a visual and/or acoustic signal, for example. A continuously consistent quality of the woven fabric can thereby be provided.

The implementation of a constant and material-friendly tension on the material in an apparatus for treating the material web represents a not insignificant challenge in terms of process technology. The material web is presently compacted in the treatment gap so as to reduce the gas-permeability. Increased tension on the material following this treatment and/or calendering would excessively stress the woven fabric material and consequently cause the weave points in the woven material to be pulled apart. The woven fabric material would be excessively stretched on account thereof. It can therefore be provided, for example, that at least after the treatment in the treatment gap and/or before the application of water, a tension and/or a tension value of the material web in the advancing direction is detected and/or the tension is in particular maintained and/or controlled so as to be consistent. Such tension control of the material web can cause at least the tension in the material web to be delimited, or else cause the tension of the tension on the material to be controlled, in particular with a view to maintaining a specific tension. A detection of the tension in the advancing direction of the material web can take place at a plurality of advantageous locations of the material web situated in an apparatus, for example, at all of the treatment steps following a first calendering process, in particular after each calendering process, after drying and/or before winding the material web onto a batch truck. A traction unit for enabling tension on the material to be built up in a targeted manner can be provided in the calender entry. The application of water can take place before or after the traction unit.

The detection of the tension can take place, for example, via a load cell known per se and/or a force measurement ring and/or other elements for measuring force.

The force which by virtue of the tension on the material acts on individual rollers can in particular be detected or determined herein.

The radial force which by virtue of the tension on the material acts on these rollers can, for example, cause a variation of the contact force of these rollers at both roller ends. This applies independently of whether these rollers are rollers with rotating journals or rollers in which a roller sleeve rotates about a non-rotating axle.

This variation of the contact force can, for example, be measured at least at one end of the roller.

Maintaining the tension on the material web, in particular compensating minor variations in the tension, can, for example, take place via a so-called dancer roller. A pendulum arm is most often actuated herein against the tension on the material web by way of a typically pneumatic cylinder with adjustable pressure. As soon as a difference exists between a material web conveying rate in the outlet region of the dancer roller and in the inlet region of the dancer roller, the position of the pendulum arm is varied so that it is possible for the length to be compensated and thus also for the tension to be kept consistent.

Active controlling of the tension on the material web can, for example, take place via the provided rollers, for example, in a roller nip, by at least partially wrapping a roller or by wrapping using an additional contact roller. Rollers which have a rubberized or roughened surface and which, for example, form a traction nip that is passed through by the material web are also, for example, driven so as to enable a gentle transportation of the material web across the entire length of the treatment apparatus. The rubberized rollers are, for example, disposed after the drying step. Instead of the rubberized rollers which form a traction nip, for example, a roller which is driven or which is able to be braked and is at least partially wrapped by the material web can also be provided, the friction fit of the roller potentially being increased on account of a rubberized or rough surface. The brake on the supply installation can also serve to control the tension on the material, for example, the brake being configured as a pneumatic brake, for example, which can apply a braking torque indirectly by way of air pressure. Further actuators for controlling the tension on the material can be formed by adjustable drive torques, in particular positive or negative drive torques, controlled, for example, by an oil pressure in the case of oil motors, or the torque on electric motors, and finally by the rotating speeds and the circumferential speeds on the driven rollers. The tension on the material can thereby, for example, be controlled to a respective envisaged value, for example, to at most 400 N/m before calendering, and to at most 250 N/m after calendering. The value of the tension before the calendering process is particularly, for example, higher than the value of the tension after the calendering process.

The apparatus according to the present invention for in particular continuously treating a textile material web in an advancing direction, in particular for reducing the gas-permeability of the material web in the thickness direction comprises at least one application installation for applying water to at least one side of planar configuration of the material web, as well as at least one treatment roller which, while conjointly with a counter tool forming a treatment gap, in the advancing direction is disposed downstream of the application installation. The advantageous method can in particular be carried out on account thereof. A reduction of the size of the woven fabric pores and, on account thereof, an effective reduction of the gas-permeability at an almost identical weight of the material web can in particular be achieved by the moistening and subsequent pressure-treatment and/or calendering as has been explained in detail above. A particularly cost-effective and environmentally friendly treatment of the material web is provided on account of the application of water as a moistening agent. The complexity in terms of cleaning the apparatus is also minimized. The produced woven fabric which is suitable for the application as an airbag is moreover particularly easy to fold and, on account thereof, is able to be packed in a particularly uncomplicated manner and by way of a relatively minor effort in terms of force. A linear force can, for example, be substantially exerted on the woven fabric that is guided through the gap in the treatment gap. The counter tool can, for example, be configured as a counter roller therefor. The counter roller, conjointly with the treatment roller, can consequently form the treatment gap, also referred to as the nip.

An embodiment of the present invention provides that the apparatus can, for example, comprise for the application of water to a first side of planar configuration of the material web, a first application installation and a first treatment roller which, while conjointly with a first counter tool forming a first treatment gap, in the advancing direction is disposed downstream of the first application installation; and for the application of water to a second side of planar configuration of the material web, a second application installation and a second treatment roller which, while conjointly with a second counter tool forming a second treatment gap, in the advancing direction is disposed downstream of the second application installation. The treatment process can thereby in particular be dual-stage so that the material web, in a first step, can first be treated on a first flat side in terms of the gas-permeability, in particular can be sprayed with water and subsequently be pressure treated and thermally treated and, in a downstream second step, can then be treated on an opposite second flat side in terms of the gas-permeability. Such a dual-stage treatment has proven to be particularly effective and advantageous.

The treatment roller can, for example, be configured so as to be temperature-controllable. The first treatment roller as well as the second treatment roller can in particular be configured so as to be temperature-controllable. In the disposal of the treatment roller and the counter tool, the treatment roller is particularly, for example, exclusively temperature-controllable so that the side of the material web that in each case is moistened can be exclusively thermally treated in the treatment gap. An evaporation of at least part of the applied water can thereby take place in a shock-like manner on the moistened side. The counter tool and/or the counter roller can in principle also be configured so as to be temperature-controllable.

The counter tool can be configured as a counter roller, in particular as a system roller, for example, as a flexurally controllable roller, for example, as a so-called floating roller or piston-supported roller. The counter roller can, for example, have a composite surface therefor. The counter roller can, for example, rotate in the opposite direction to the treatment roller. The treatment roller can, for example, be configured as a steel roller with a steel surface. Such a pairing of rollers, in particular a combination of the smooth steel surface acting in relation to a softer composite surface, has proven advantageous for treating the material web, in particular for reducing the gas-permeability.

In order to be able to adhere to envisaged values for the gas-permeability which during the treatment method are, for example, measured online, the surface at least of the counter roller in one embodiment of the present invention has the following parameters: system roller with the cylindrical fiber-composite material; hardness at 20° C. of 92+/−3 Shore D; hardness at 100° C. of 89+/3 Shore D. The treatment roller herein is a steel roller which is, for example, hard-chromium plated.

In a refinement of the present invention, at least one dryer, for example, a steam-heated dryer, is provided for drying the material web, the dryer in the advancing direction potentially being downstream of the last treatment gap. The material web can thereby be completely dried, for example, for further downstream treatment steps. The dryer can advantageously be configured as a cylinder dryer, in particular with a stainless steel surface.

A material unwinding installation can, for example, be provided for unwinding the material web from the first supply installation such as a first batch truck, and a material winding installation can, for example, be provided for winding the material web onto a second supply installation such as a second batch truck. Standardized batch trucks can thereby in particular be used for use with the apparatus.

A brake installation for braking a storage roll, carrying the material web, of the first batch truck, in particular for decelerating the unwinding procedure, can be provided on at least the material unwinding installation. The brake can, for example, be configured as a disk brake, a drum brake, or a strap brake, which are known per se. The brake is, for example, actuatable in an electronic, hydraulic or pneumatic manner. A disk brake disposed on a bracket can in particular, for example, be positioned and installed laterally on the first batch truck. Customer-provided batch trucks which are not equipped with a brake can also, for example, be connected to such a brake disposed, for example, on the apparatus by way of an articulated shaft or a belt. The material web can thereby be unwound in a tension-controlled manner and without creases across the circumference.

In the material winding installation, the non-stretched, compacted woven fabric material by way of a center winder can be wound at low tension and in a gentle and industry-appropriate manner onto a supply installation such as a storage roll and/or a tube of a second batch truck. The second batch truck by way of an articulated arm, for example, can thereby be connected to a drive on the apparatus, in particular a rotary drive, for driving the storage roll of the second batch truck.

The present invention can, for example, provide that a dancer roller and/or a load cell for setting the tension on the material are/is disposed in the advancing direction between a material unwinding installation for unwinding the material web from a batch truck and an in particular first spraying installation, between a treatment gap and a spraying installation, between a treatment gap and a dryer, and/or between the dryer and a material winding installation for winding the material web onto a batch truck. The dancer roller and/or the load cell can in particular be provided for maintaining a defined tension on the material, for example, a pre-tension force of 250 N/m. Such monitoring of the tension is particularly advantageous at the exit of the calender. An almost identical tensile force, in particular tension, on the material web in the advancing direction can thereby be achieved across the entire apparatus. A force measurement ring and/or another element for measuring force can be used instead of or in addition to the load cell.

An exemplary embodiment of the present invention will be explained in greater detail hereunder under reference to the drawings.

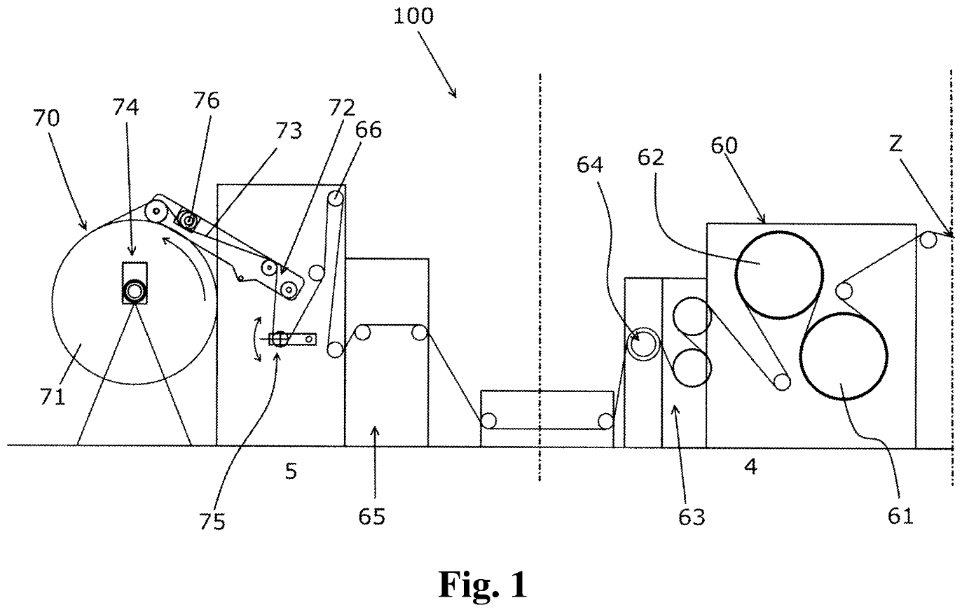

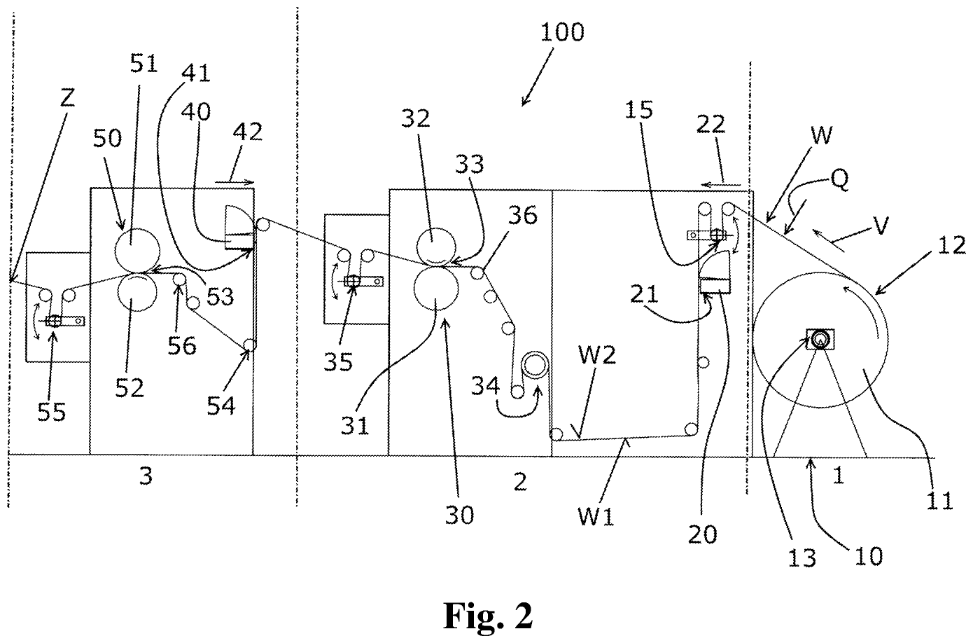

FIGS. 1 and 2 in a combined view and/or an overall view schematically show an embodiment of the apparatus 100 according to the present invention for treating a textile material web W in a lateral sectional view. FIG. 1 forms the left image part of the overall view, and FIG. 2 forms the right image part of the overall view. Point Z can be considered the overlap point and indicates in each case one and the same location of the apparatus 100. According to an advancing direction V of the material web W guided through the apparatus 100, FIG. 2 relates to a first and/or upstream portion of the apparatus 100, and FIG. 1 relates to a second portion of the apparatus 100 that is downstream of the first portion.

The treatment carried out by way of the apparatus 100 shown in FIGS. 1 and 2 serves to reduce the gas-permeability of the material web W, in particular in the thickness direction Q, and can be a component part of a production line which is presently not shown and potentially comprises further components.

The thickness direction Q of the material web W is in each case to be understood as the direction which is substantially perpendicular to at least one of the two flat sides W1, W2 of planar configuration of the material web W, in particular substantially perpendicular to an upper side such as the first flat side W1, for example, and to a lower side such as the second flat side W2 of the material web W, for example. The thickness direction Q shown in FIG. 2 is therefore to be understood only as an example for the specifically shown location of the material web W; the orientation of the thickness direction Q in particular varies as a function of a variation of the profile of the material web W.

The apparatus 100 can be sub-divided into a plurality of sections 1, 2, 3, 4, 5, which are presently delimited by dashed vertical lines and which are passed by the material web W in the advancing direction V, presently in particular from the right periphery of the image of FIG. 2 to the left periphery of the image of FIG. 1.

Unwinding of the material web takes place in section 1. A material unwinding installation 12 is provided to this end. The material unwinding installation 12 enables the material web W to be unwound in a tension-controlled manner from a supply installation 11, presently from a storage roll of a batch truck 10, also referred to as a batch roll truck. The storage roll 11 rotates in the direction of the arrow shown during the unwinding procedure. In order to prevent the storage roll 11 from rotating too fast, in particular so as to avoid that the material web runs off or away from the storage roll 11, and so as to be able to unwind or unroll the material web W without creases and in a tension-controlled manner from the storage roll 11, a brake 13 for decelerating the rotating movement of the storage roll 11 is provided on the storage roll 11, for example, on the batch truck 10. The brake 13 can, for example, be configured as a multi-disk brake.

Section 2 comprises an entry frame for introducing the material web W in the advancing direction V into the apparatus 100, wherein a first dancer roller 15 which serves to control the tension on the material web W in the advancing direction V in the region of the material unwinding installation 12 is provided. As soon as the first dancer roller 15 detects that a previously defined nominal tension value is exceeded, in particular on account of the first dancer roller 15 which is repositionable to a limited extent being repositioned, this in FIGS. 1 and 2 being in each case shown by the double arrow, a signal is transmitted to the brake 13 so that the brake 13 is at least partially released and the tension in the material web W can thereby be reduced. When the tension in the material web W decreases, the brake 13 at least partially intervenes again and thereby retains the material web so as to increase and, for example, maintain the tension on the material.

In a next step, the material web W is guided past a first application installation 20 which is configured as a spraying installation. The first application installation 20 serves to apply water to the material web W and therefore comprises one or a plurality of rotary moistening apparatuses 21 or classic spray nozzles, for example bi-component spray nozzles. The first application installation 20 is disposed relative to the material web W guided through the apparatus 100 so that a first flat side W1 of planar configuration of the material web W is exclusively sprayed with water. The first application installation 20 thereby sprays in a defined spraying direction which is indicated by the arrow 22. The other second flat side W2 of planar configuration, in particular the second side or flat side, of the material web W is in particular not sprayed or moistened with water. The material web W is thereafter guided relatively far downward, in particular below a platform (which is not illustrated in greater detail) which serves to render the machine accessible to an operator, and is thereafter guided by way of a traction unit/entry rollers 34, and an expander roller 36 to a first calender installation 30.

The first calender installation 30 comprises a first treatment roller 31 which conjointly with a first counter roller 32 configures a first treatment gap 33, wherein the material web W is guided through the first treatment gap 33. The first treatment roller 31 is configured as a temperature-controllable steel roller with a chrome-plated surface on which the material web W bears or is in contact with by way of the first flat side W1 which has previously been sprayed with water. On account of the heat emanating from the first treatment roller 31 and the pressure prevailing in the first treatment gap 33, the water situated on the first flat side W1 can be evaporated, and a compacting effect can be caused in the woven fabric of the material web W which reduces the size of and/or closes the woven fabric pores, and thus establishes a compacting effect of the woven fabric, in particular on account of the combination of temperature, pressure and dwell time, the latter being related to the material web speed. It can herein be favorable for the wrapping angle of the material web W on the first treatment roller 31 which is heated to be adapted so as to achieve a certain degree of pre-heating of the material web W. The first calender installation 30 furthermore comprises a frame on which the two rollers 31, 32 are mounted, a hydraulic unit, a lubricating unit, as well as a dancer roller 35 for controlling the tension on the material in the material web exit.

The dancer roller 35 functions according to the manner already described above in the context of the first dancer roller 15, and in the present disposal controls the tension on the material web W in the region of an outlet of the first treatment gap 33. In order for the tension on the material to be controlled, the dancer roller 35 can emit a signal, presently to a control unit of the first calender installation 30, for example, in order to accelerate or decelerate the rotating action of the roller.

A second application installation 40 in the section 3 is directly adjacent to the first calender installation 30. The second application installation 40 again serves to spray the material web W with water and therefore comprises one or a plurality of spray nozzles and/or rotary moistening apparatuses 41. The second application installation 40 is disposed relative to the material web W guided through the apparatus 100 so that the second flat side W2 of the material web W is exclusively sprayed with water. The second application installation 40 therefore sprays in a defined spraying direction which is indicated by the arrow 42. The first flat side W1 is in particular not sprayed or moistened with water. The second application installation 40 is configured so as to be of substantially identical construction as the first application installation 20. The material web W, after moistening on one side, is fed to a second calender installation 50, in the exemplary embodiment illustrated again by way of entry rollers 54 and an expander roller 56. A traction unit (which is not illustrated) can also optionally be disposed ahead of the expander roller 56.

The second calender installation 50 comprises a second treatment roller 51 which conjointly with a second counter roller 52 configures a second treatment gap 53, wherein the material web W is guided through the second treatment gap 53. The second treatment roller 51 is again configured as a temperature-controllable steel roller having a chrome-plated surface. The material web W bears on this surface by way of the second flat side W2 which has previously been sprayed with water. On account of the heat emanating from the second treatment roller 51 and the pressure prevailing in the second treatment gap 53, the water situated on the second flat side W2 can now evaporate, thereby supporting a compacting effect in the woven fabric of the material web W on this side. The second calender installation 50 likewise comprises a frame on which the two rollers 51, 52 are mounted, a hydraulic unit, a lubricating unit, as well as a dancer roller 55 for controlling the tension on the material in the material web exit.

The dancer roller 55 functions according to the manner already described above in the context of the first dancer roller 15, and in the present disposal controls the tension in the material web W in the region of an outlet of the second treatment gap 53. In order for the tension on the material to be controlled, the dancer roller 55 can emit a signal, presently to a control unit of the second calender installation 50, for example, in order to accelerate or decelerate the rotating action of the roller.

The section 4 which in the advancing direction V follows the second calender installation 50 serves to dry the material web W. A drying installation 60 is provided therefor. The drying installation 60 is configured as a cylinder dryer having two drying cylinders 61, 62 and/or hot cylinders. The drying cylinder 61, 62 across the circumference thereof have a stainless steel surface on which the material web W bears in each case by way of a flat side W1, W2. The material web W by way of the second flat side W2 in particular presently bears on the first drying cylinder 61 and by way of the first flat side W1 on the second drying cylinder 62. The woven fabric which has previously been charged with water and/or moisture can thereby be effectively and completely dried. By virtue of the application of pure water, any sticking, adhering or remaining residual material is not expected. Alternative drying methods or drying apparatuses which are presently not shown are likewise conceivable. In an assembly downstream of the drying installation 60, the material web W runs in particular in an S-shaped manner through a cooling insulation 63 which cools the material web W and which comprises two cooling rollers. A rubberized roller 64 for controlling the tension on the material web W is again subsequently provided.

Before the material web W in the last section 5 and in a last step is again wound onto a supply installation 71, in particular a storage roll of a batch truck 70, the material web W is again guided relatively far downward so that a platform or catwalk (which is not illustrated) for an operator can be disposed above the material web W. Continuous measuring of the gas-permeability of the completely calendered woven fabric moreover takes place in a gas-permeability testing installation 65. The gas-permeability and thus the result of the calendering effects can thus be continuously checked. In order for the tension on the material web W to be controlled, a load cell 66 is provided directly ahead of the step of winding.

A center winder 73 is provided for winding the material web W onto the storage roll 71. The storage roll 71 can in particular be set in rotation therefor, for example via an AC drive motor 74. The storage roll 71 rotates in the direction of the arrow during the winding procedure. The center winder 73 thus provides the material web W to be wound at low tension and in a crease-free and surface-friendly manner onto the storage roll 71. At the beginning of the winding procedure, the center winder 73 in relation to the circumference of the wound roll is disposed so as to be relatively close to a shaft of the storage roll 71, this being shown by way of the material web W plotted with the dashed line. At the end of the winding procedure, the center winder 73 is pivoted relatively far upward, as shown, so that the material web can be uniformly wound on the growing circumference of the storage roll 71. In order to avoid the formation of creases, an expander roller 76 can be provided which interacts with the material web. The material web W can alternatively be fed to an installation (which is not illustrated) which is downstream of the apparatus 100, for example, an installation for coating the woven fabric.

The drive motor 74, in a manner similar to the brake 13 on the entry-side first batch truck 10, can be disposed on an assembly bracket, in particular so as to be laterally beside the center winder 73, or the batch truck 70, and be connected to the shaft of the storage roll 71, for example, via an articulated shaft or a belt (which is not illustrated in greater detail). The dancer roller 75 serves to control the drive motor 74 as a function of the tension on the material web W detected in this region, the dander roller 75 being able to emit a signal for adapting and/or controlling, in particular accelerating or decelerating, the drive speed at the drive motor 74.

In summary, the material web W is guided at least through the following components of the apparatus 100 which in the advancing direction V are disposed in this sequence: material unwinding installation 12, first dancer roller 15, first application installation 20, first treatment gap 33, dancer roller 35, second application installation 40, second treatment gap 53, dancer roller 55, drying installation 60, cooling installation 63, gas-permeability testing installation 65, dancer roller 75, and winding installation 72.

It is to be understood that the scope of protection of the present invention is not limited to the exemplary embodiment described. In particular the construction and the disposal of the individual rollers, rolls, and testing/controlling installations such as the dancer roller and the gas-permeability testing installation, can be readily modified without departing from the core concept of the present invention. Reference should also be had to the appended claims.

### LIST OF REFERENCE NUMERALS

1 Section
2 Section
3 Section
4 Section
5 Section
10 Batch truck
11 Supply installation/Storage roll
12 Material unwinding installation
13 Brake
15 First dancer roller
20 First application installation
21 Rotary moistening apparatus/Spray nozzle
22 Spraying direction
30 First calender installation
31 First treatment roller
32 First counter roller
33 First treatment gap
34 Traction unit/Entry rollers
35 Dancer roller
36 Expander roller
40 Second application installation
41 Rotary moistening apparatus/Spray nozzle
42 Spraying direction
50 Second calender installation
51 Second treatment roller
52 Second counter roller
53 Second treatment gap
54 Entry roller
55 Dancer roller
56 Expander roller
60 Drying installation
61 First drying cylinder
62 Second drying cylinder
63 Cooling installation
64 Rubberized roller
65 Gas-permeability testing installation
66 Load cell
70 Batch truck
71 Supply installation/Storage roll
72 Winding installation
73 Center winder
74 Drive motor
75 Dancer roller
76 Expander roller
100 Apparatus
Q Thickness direction
V Advancing direction
W Material web
W1 First flat side
W2 Second flat side
Z Overlap point

What is claimed is:

1-15. (canceled)

16: A method for treating a textile material web for reducing a gas-permeability of the textile material web, the method comprising:
providing the textile material web comprising a first side having a planar configuration and a second side having a planar configuration, the first side being opposite to the second side;
transporting the textile material web in an advancing direction; and
reducing the gas permeability of the textile material web in a first step which comprises,
applying water to at least one of the first side and the second side of the textile material web,
guiding the textile web material through a first treatment gap which is formed by a first treatment roller and a first counter tool, and
in the first treatment gap, pressure treating the textile material web and thermally treating at least one of the first side and the second side of the textile material web.

17: The method as recited in claim 16 further comprising:
drying the textile material web after pressure treating and thermally treating the textile material web in the first treatment gap.

18: The method as recited in claim 16, wherein, before applying the water in the first step, the method further comprises:
receiving the material web from a first supply installation or from an upstream installation.

19: The method as recited in claim 18, wherein the first supply installation is a first batch truck.

20: The method as recited in claim 16, further comprising:
at least one of detecting and controlling a tension value of the textile material web in the advancing direction at least one of,
before applying the water, and
after pressure treating and thermally treating the textile material web in the in the first treatment gap.

21: The method as recited in claim 16, wherein,
in the first step,
water is applied only to the first side of the textile material web, and
in the first treatment gap, the textile material web is pressure treated and only the first side is thermally treated, and
the method further comprises reducing the gas permeability of the textile material web in a second step which comprises:
applying water only to the second side of the textile material web;
guiding the textile web material through a second treatment gap which is formed by a second treatment roller and a second counter tool; and
in the second treatment gap, pressure treating the textile material web and thermally treating only the second side of the textile material web.

22: The method as recited in claim 21 further comprising:
drying the textile material web after pressure treating and thermally treating the textile material web in the second treatment gap.

23: The method as recited in claim 21, further comprising:
at least one of detecting and controlling a tension value of the textile material web in the advancing direction at least one of,
before applying the water, and
after pressure treating and thermally treating the textile material web in the in the second treatment gap.

24: The method as recited in claim 16, further comprising:
winding the textile material web onto a second supply installation.

25: The method as recited in claim 24, wherein the second supply installation is a second batch truck.

26: The method as recited in claim 16, further comprising:
testing the textile material web so as to detect a gas-permeability value.

27: An apparatus for treating a textile material web in an advancing direction so as to reduce a gas-permeability of the textile material web, the textile material web comprising a first side having a planar configuration and a second side having a planar configuration, the first side being opposite to the second side, the apparatus comprising:
at least one installation which is configured to apply water to at least the first side and the second side of the textile material web;
at least one treatment roller; and
at least one counter tool,
wherein,
the at least one treatment roller and the at least one counter tool together form a treatment gap in the advancing direction which is arranged downstream of the at least one installation.

28: The apparatus as recited in claim 27, wherein,
at least one installation comprises a first application installation and a second application installation which is arranged downstream of the first application installation,
the at least one treatment roller comprises a first treatment roller and a second treatment roller which is arranged downstream of the first treatment roller,
the at least one counter tool comprises a first counter tool and a second counter tool which is arranged downstream of the first counter tool,
the first treatment roller and the first counter tool together form a first treatment gap in the advancing direction which is arranged downstream of the first application installation,
the second treatment roller and the second counter tool together form a second treatment gap in the advancing direction which is arranged downstream of the second application installation,
the first application installation is provided to apply water to the first side of the textile material web in the advancing direction, and
the second application installation is provided to apply water to the second side of the textile material web in the advancing direction.

29: The apparatus as recited in claim 27, wherein at least of,
each of the at least one treatment roller, and
each of the at least one the counter tool,
is configured to be temperature-controllable.

30: The apparatus as recited in claim 27, wherein at least one of,
each of the at least one treatment roller is configured as a steel roller, and
each of the at least one counter tool is configured as a roller.

31: The apparatus as recited in claim 30, wherein the roller is a flexurally controllable roller.

32: The apparatus as recited in claim 27, further comprising:
at least one drying installation which is configured to dry the textile material web.

33: The apparatus as recited in claim 28, further comprising:
a first supply installation which is configured to supply the textile material web;
a material unwinding installation which is configured to unwind the textile material web from the first supply installation;
a second supply installation which is configured to receive the textile material web; and
a material winding installation which is configured to wind the textile material web onto the second supply installation.

34: The apparatus as recited in claim 33, further comprising:
a dancer roller which is configured to set a tension on the textile material web, the dancer roller being arranged, in the advancing direction, at at least one of,
between the material unwinding installation and the first application installation,
between the first treatment gap and the second application installation,
between the second treatment gap and the drying installation, and
between the drying installation and the material winding installation.

35: The apparatus as recited in claim 27, wherein each of the at least one application installation is configured as at least one of,
a spraying installation comprising a spray nozzle which is configured to spray water, and
a rotary moistening apparatus.
